(19) United States
(12) Patent Application Publication
(10) Pub. No.: US 2015/0300078 A1
(43) Pub. Date: Oct. 22, 2015

(54) Confined Space Cover

(71) Applicants: Thomas Jefferson Porter IV, League City, TX (US); Merlina Bajrami Porter, League City, TX (US)

(72) Inventors: Thomas Jefferson Porter IV, League City, TX (US); Merlina Bajrami Porter, League City, TX (US)

(21) Appl. No.: 14/687,323

(22) Filed: Apr. 15, 2015

Related U.S. Application Data
(60) Provisional application No. 61/980,177, filed on Apr. 16, 2014.

(51) Int. Cl. E06B 9/01; E06B 9/52; G09F 7/00; E06B 9/00

(52) U.S. Cl. CPC E06B 9/01; E06B 9/00; E06B 9/521; G09F 7/00; E06B 2009/002; E06B 2009/015; E06B 2009/524; E06B 2009/527; G09F 2007/1852

(57) ABSTRACT

A confined space cover that covers a man-way to a confined space area in a vessel. The cover includes a base cover secured to the vessel by sections hook-and-loop fabric or, in the case of magnetic vessels, magnets. The cover may also include a warning sign disposed on the front of the base cover to prevent persons from entering the confined space area.

### CROSS REFERENCE TO RELATED APPLICATION

This application claims priority to U.S. Application No. 61/980,177 filed on Apr. 16, 2014 the disclosure of which is incorporated herein by reference for all purposes.

### FIELD OF THE INVENTION

The present invention is directed to covers for confined spaces. More particularly, the present invention is directed to covers for entryways into confined spaces.

### BACKGROUND OF THE INVENTION

There is currently a plurality of confined space control devices available that address confined space areas typically found at chemical plants, refineries, etc. The primary function of the confined space control devices is to alert nearby personnel of confined space areas, e.g., man-ways. The warnings provided by these confined space control devices are often insufficient at preventing fatalities and injuries at the chemical, refining, and other heavy industry facilities where they are typically employed.

Typical confined space control devices are simply comprised of barricade tape, chem tape, wire, and signs. They do not prevent a person from breaking the plane of the confined space and they may be easily overlooked or disregarded by the personnel they are intended to protect. There is a need in the industry for a confined space control cover which covers the entire man-way, such that a person is not able to disregard the presence of the control device and break the plane of the confined space.

There is also a problem with confined space control devices being manipulated and removed by unauthorized personnel. These individuals are sometimes entering the confined space without the proper authorization and are becoming injured or killed. This deficiency can be cured with a lockable confined space cover as described in U.S. Pat. No. 8,684,061 and U.S. application Ser. No. 14/176,530 filed Feb. 10, 2014. However, some man-way entrances do not have flanges. There is a need in the industry for a man-way or confined space cover which prevents an individual from breaking the plane of the confined space and which covers flangeless man-ways.

### SUMMARY OF THE INVENTION

It one aspect, the present invention provides a confined space cover which can be securely placed over any man-way leading to a confined space which can be in a tower, a vessel, a tank or other confined space location or area.

In another aspect, the present invention provides a confined space cover which restricts an individual from being able to break the plane of a man-way or similar opening into a confined space.

In still another aspect, the present invention provides a cover for removably securing over the opening to a confined space, the cover being easily and quickly installed.

These and further features and advantages of the present invention will become apparent from the following detailed description, wherein reference is made to the figures in the accompanying drawings.

### BRIEF DESCRIPTION OF THE DRAWINGS

FIG. 1 is an environmental, elevational view of one embodiment of the present invention.

FIG. 2 is a cross-sectional view taken along the line 2-2 of FIG. 1.

FIG. 3 is a partial view of the embodiment of FIG. 1 showing details of securing the cover over the opening to the confined space.

FIG. 4 is a view similar to that of FIG. 2, but shown on a different man-way.

FIG. 5 is an environmental, elevational view of another embodiment of the present invention.

FIG. 6 is a cross-sectional view taken along the line 6-6 of FIG. 5.

FIG. 7 is an environmental, elevational view of yet another embodiment of the present invention.

FIG. 8 is an environmental, elevational view of yet another embodiment of the present invention.

FIG. 9 is a cross-sectional view taken along line 9-9 of FIG. 8.

FIG. 10 is a cross-sectional view taken along line 10-10 of FIG. 8.

FIG. 11 is similar to FIG. 8, but shows the present invention on a different man-way.

FIG. 12 is a cross-sectional view taken along line 12-12 of FIG. 11.

### DETAILED DESCRIPTION OF PREFERRED EMBODIMENTS

As used herein confined space refers to any confined or enclosed space in any structure, e.g., vessel, tower, tank or the like in which personnel or workers may need to enter for specific purposes. The entrances to the confined spaces, referred to herein as man-ways, can vary in shape and size, some allowing a person to simply step through into the confined space and others requiring a person to crawl or slide through into the confined space. The above definitions are explanatory only. It will be understood that the present invention is not limited to any particular man-way or any particular confined space.

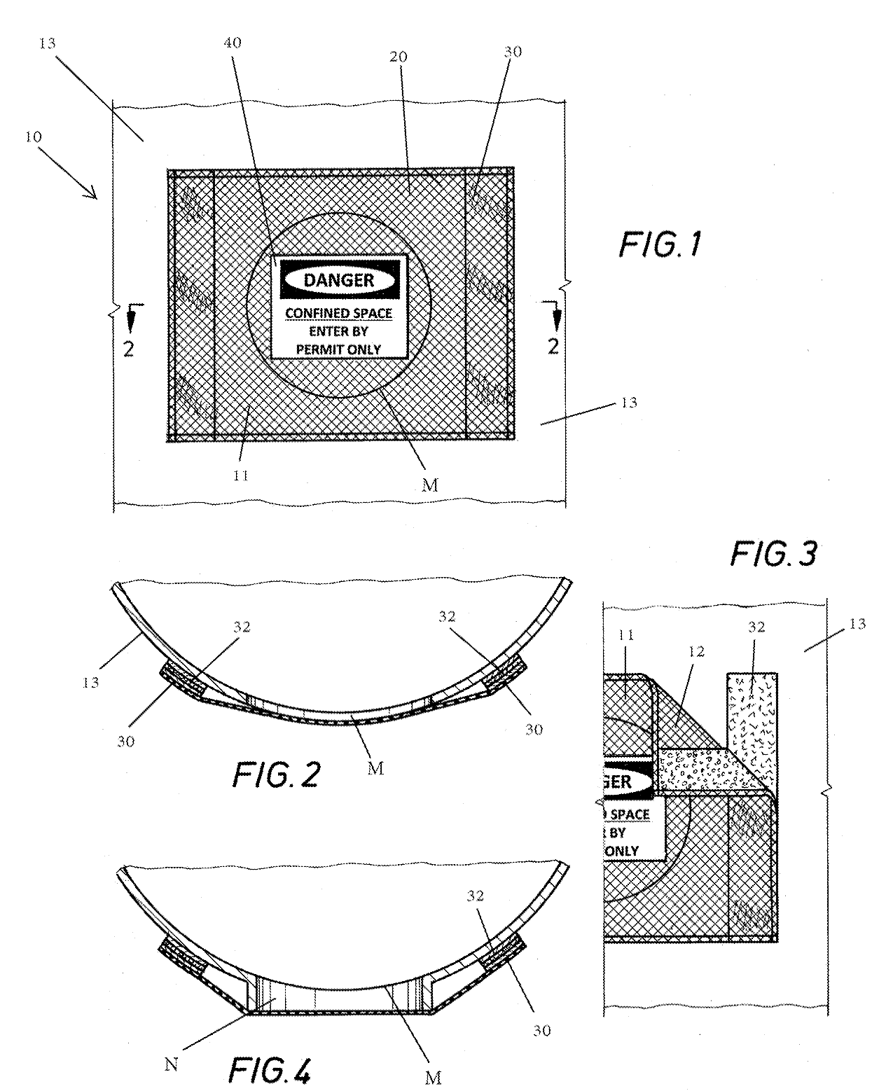

FIG. 1 illustrates a confined space cover 10 in accordance with one embodiment of the present invention. The confined space cover 10 includes a front surface 11, a back surface 12, at least one strip of hook-and-loop fabric 30 (such as Velcro® fabric) attached to the back surface 12, and a mating strip of hook-and-loop fabric 32 (see FIG. 3) attached to the vessel or the like 13 in generally surrounding relationship to a man-way leading to a confined space in the vessel 13. The fabric strip 32 is attached to the vessel 13 by an epoxy or the like which is able to meet all the temperature and weather requirements of the user. As shown in FIG. 1, the cover 10 has two sets of hook-and-loop strips 30 and 32 on either side of the man-way M. It will be understood though that the hook-and-loop strips can be in other configurations as well. Some non-limiting examples include 1) one set of strips only along the top, 2) one set of strips along the top and one set along the bottom, and 3) one set of strips along the top and one set along one side. Additionally, the cover 10 may be round in shape and have a hook-and-loop strip along the outer periphery, or multiple hook-and-loop strips spaced from one another along the outer periphery.

The unique design of cover 10 allows the confined space cover 10 to be securely placed over man-ways of varying size. This eliminates the need for specially sized covers for each man-way.

Cover 10 may include a warning sign 40, typically disposed on the front surface 11 of the cover 10. The warning sign 40 is typically an occupational safety and health administration or OSHA or other safety regulatory agency sign although the warning sign 40 may be any suitable safety warning sign. More specifically, the warning sign 40 may read “DANGER CONFINED SPACE AREA” or other suitably related confined space warning sign wording.

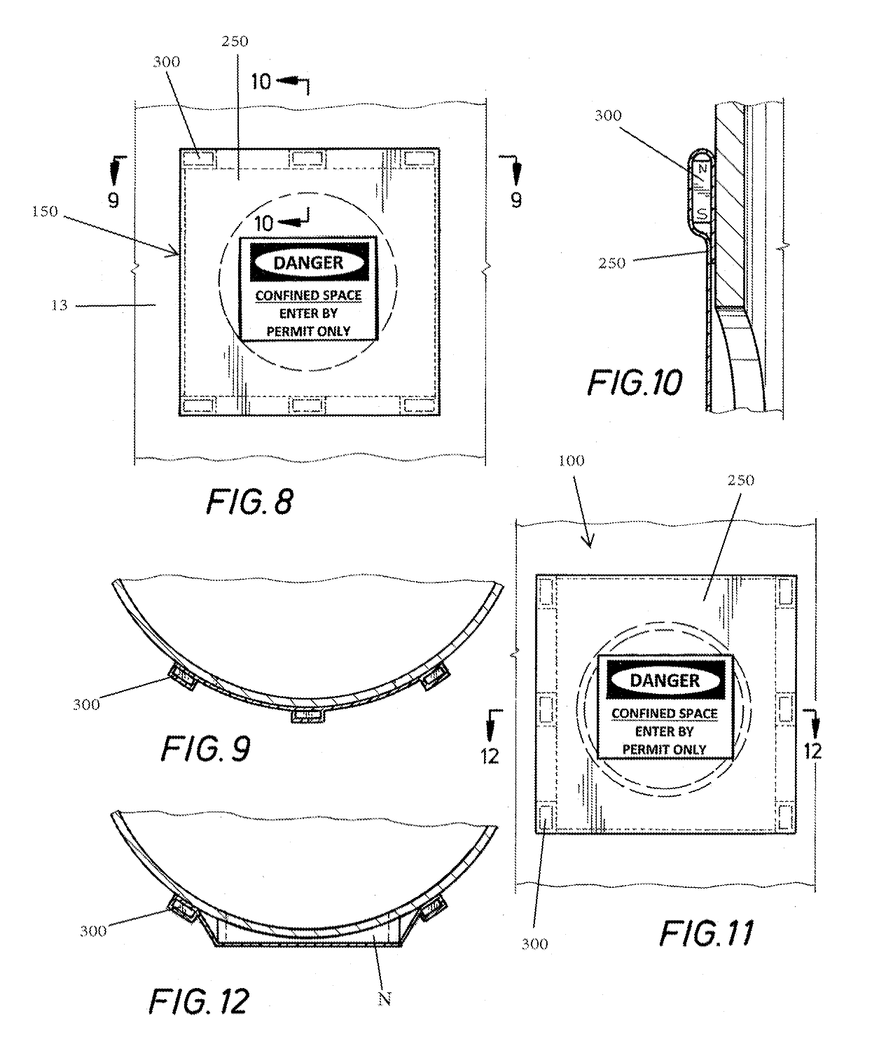

The confined space cover 10 is securely placed over any confined space man-way that is on any structure having a chamber or the like to which the man-way leads and restricts persons being able to break the plane of the man-way. Cover 10 warns persons in the surrounding area that a confined space area (not shown) is secured and prevents them from entering it without first removing the cover. The cover 10 can be made of chemical resistant fabric 20 that will be manufactured in either an open mesh or a solid waterproof fabric (see FIG. 8), although the cover 10 can be made of other suitable types of fabric and material as well.

FIG. 2 shows the strips 30 and 32 engaged to hold the cover 10 over the man-way M.

FIG. 3 shows the cover 10 peeled back at one corner to reveal hook-and-loop strip 32 which is affixed to vessel 13.

FIG. 4 shows cover 10 over a man-way M which has an externally protruding neck N.

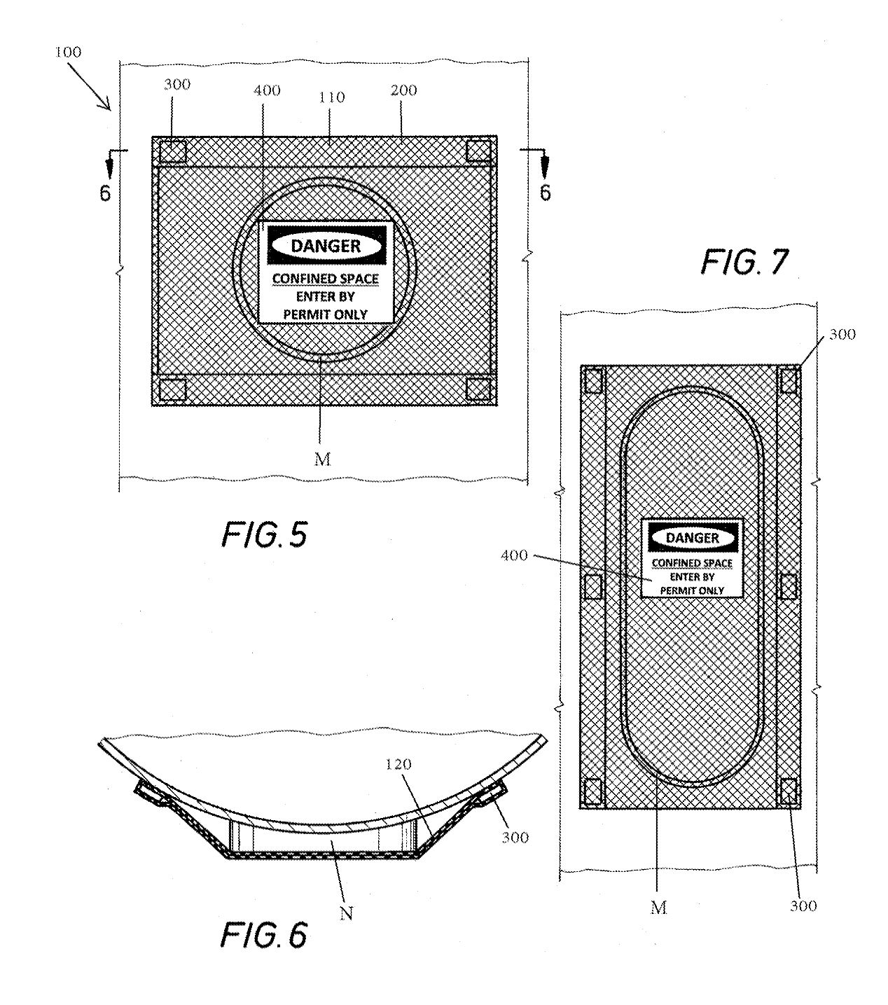

FIGS. 5 and 6 show another embodiment of the cover of the present invention. The confined space cover 100 includes a front surface 110, a back surface 120, a series of four magnets 300 near the four corners of the cover 100. As best seen in FIG. 10, the magnets 300 are held in place in the cover 100 by folding the peripheral edges of the cover 100 over the magnets 300 and sewing the ends to form a pocket or channel. It will be appreciated that the magnets 300 can be held in place by any method, including but not limited to sewing additional pieces of fabric to cover 100 or attaching the magnets 300 with an appropriate adhesive. The embodiment shown in FIG. 5 is intended only for vessels or other structures having a confined space and which are at least partially made of magnetic material, e.g., iron or steel. As shown in FIG. 5, the cover 100 has a magnet 300 in each of the four corners. It will be understood and appreciated though that the magnets 300 can be positioned in other configurations as well. Additionally, the cover 100 may be round in shape and have a plurality of magnets 300 spaced along the outer periphery.

This unique design allows the confined space cover 100 to be securely placed over man-ways of varying shape and size. This eliminates the need for specially sized covers for each man-way.

Cover 100 may include a warning sign 400, typically disposed on the front surface 110 of the cover 100. The warning sign 400 is typically an occupational safety and health administration or OSHA or other safety regulatory agency sign although the warning sign 4000 may be any suitable safety warning sign. More specifically, the warning sign 400 may read “DANGER CONFINED SPACE AREA” or other suitably related confined space warning sign wording.

The confined space cover 100 is securely placed over any confined space man-way that is on any structure having a chamber or the like to which the man-way leads and restricts persons being able to break the plane of the man-way. Cover 100 warns persons in the surrounding area that a confined space area (not shown) is secured and prevents them from entering it without first removing the cover 100. The cover 100 can be made of chemical resistant fabric 200 that will be manufactured in either an open mesh or a solid waterproof fabric (see FIG. 8), although the cover 100 can be made of other suitable types of fabric and material as well.

FIG. 7 shows another shape of cover 100 which has six magnets 300 spaced along the sides. The cover 100 is positioned over a larger man-way M.

FIGS. 8 and 9 show a cover 100 made of solid waterproof fabric 250. The magnets 300 are shown spaced along the top and bottom of cover 100.

FIG. 10 shows one embodiment of how magnets 300 are held in place. The outer edge of cover 100 is folded over the magnet 300 to form a pocket. The fabric may be held together by any known means, including, sewing, stapling, or using an appropriate adhesive.

FIGS. 11 and 12 show another example of a cover 100 made of solid waterproof fabric 250, with the magnets 300 spaced along the sides. The cover 100 is positioned over a man-way M having an externally protruding neck N.

In addition to keeping people from breaking the plane of opening to the confined space without first removing the cover, the cover of the present invention depicted in FIGS. 8-12 can also provide an excellent barrier from water, dust and other elements.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A system for restricting access to a manway to a confined space area in a vessel comprising:
a base cover having a first side, a second side, and a peripherally outermost edge;
a first section of hook-and-loop fabric affixed to said second side proximal said peripherally outermost edge;
a second section of hook-and-loop fabric affixed to said vessel proximal said manway, said first section of hook-and-loop fabric being engagable with said second section of hook-and-loop fabric when said base cover is placed over said manway.

2. The system of claim 1, wherein said second section of hook-and-loop fabric is affixed to said vessel by an adhesive.

3. The system of claim 1, further comprising:
a third section of hook-and-loop fabric affixed to said second side proximal said peripherally outermost edge;
a fourth section of hook-and-loop fabric affixed to said vessel proximal said manway, said third section of hook-and-loop fabric being engagable with said fourth section of hook-and-loop fabric when said base cover is placed over said manway.

4. The system of claim 3, wherein said fourth section of hook-and-loop fabric is affixed to said vessel by an adhesive.

5. The system of claim 1, wherein said base cover is made of waterproof chemical resistant fabric or chemical resistant breathable fabric.

6. The system of claim 1, further comprising:
a warning sign disposed on said first side of said base cover.

7. The system of claim 6, wherein said warning sign is an OSHA sign.

8. A system for restricting access to a manway to a confined space area in a vessel being at least partially formed of magnetic material, comprising:
a base cover having a first side, a second side, and a peripherally outermost edge;
a pocket disposed proximal said peripherally outermost edge;
a magnet disposed in said pocket.

9. The system of claim 8, further comprising:
a plurality of pockets disposed proximal said peripherally outermost edge;
a plurality of magnets, each of said plurality of magnets disposed in a respective one of said plurality of pockets.

10. The system of claim 8, wherein said pocket is formed by sewing an additional piece of material to said base cover.

11. The system of claim 8, wherein said base cover is made of waterproof chemical resistant fabric or chemical resistant breathable fabric.

12. The system of claim 8, further comprising:
a warning sign disposed on said exterior surface of said base cover.

13. The system of claim 12, wherein said warning sign is an OSHA sign.
